(19) United States
(12) Patent Application Publication
(10) Pub. No.: US 2025/0061422 A1
(43) Pub. Date: Feb. 20, 2025

(54) DIGITAL PLATFORM FOR COLLABORATION BETWEEN ENTITIES IN ENERGY-RELATED PROJECTS

(71) Applicant: Schlumberger Technology Corporation, Sugar Land, TX (US)

(72) Inventors: Wiebke Athmer, Tananger (NO); Aicha Bounaim, Tananger (NO); Tom Jonsthovel, Lysaker (NO)

(21) Appl. No.: 18/723,554

(22) PCT Filed: Feb. 17, 2022
(86) PCT No.: PCT/US2022/070688

§ 371 Date: Jun. 24, 2024

(51) Int. Cl. G06Q 10/10

(52) U.S. Cl. CPC G06Q 10/103

(57) ABSTRACT

A digital platform is provided that is accessed by a plurality of users that represent entities that provide services or facilities related to carbon capture and storage projects. The platform executes at least one process configured to enable collaboration between users for carbon capture and sequestration projects. Additionally or alternatively. the platform can be configured for access by users that represent entities that provide services or facilities related to other energy-related projects, such as hydrogen projects and geothermal projects. The platform can be configured to execute at least one process configured to enable collaboration between users for energy-related projects.

### FIELD

The present disclosure relates generally to energy-related projects, including carbon capture and storage, and, more particularly, to planning and implementing energy-related projects.

### BACKGROUND

Carbon capture and storage (sometimes also referred to as carbon capture, utilization, and storage) plays a critical role in the decarbonization of industry. According to the International Energy Agency (IEA) and the International Panel on Climate Change (IPCC), carbon capture and storage can contribute to more than 50% of the emission reductions by 2050 and is essential to limit global warming to below 2° C. (IEA, IPCC). Carbon capture and storage is crucial because it enables the reduction of industrial large-scale emissions in hard-to-abate industries, like cement and steel. Yet, as of now, industries struggle to start carbon capture and storage projects because such projects are often complex, with many stakeholders, resulting in high costs and low margins. Furthermore, a general lack of understanding of expected costs, tax consequences, potential partners and existing projects has slowed down the deployment of new large-scale carbon capture and storage projects—despite their urgent need. At the same time, oil and gas operators and service providers own or control data and knowledge on carbon storage that can benefit industry partners to implement carbon capture and storage projects more efficiently.

### SUMMARY

A digital platform is provided that is accessed by a plurality of users that represent entities that provide services or facilities related to carbon capture and storage projects. The platform executes at least one process configured to enable collaboration between users for carbon capture and sequestration projects.

In embodiments, the at least one process can be configured to enable a user to identify at least one potential partner related to a carbon capture and sequestration project. The at least one potential partner can include at least one user of the platform and/or at least one entity that is not a user of the platform.

In embodiments, the at least one process can be configured to enable collaboration between users and exchange of services related to carbon capture and sequestration projects.

In embodiments, the at least one process can be configured to present for display a user interface to a user, the user interface enabling the user to specify a set of input parameters that are used to identify at least one potential partner for a carbon capture and storage project, wherein the at least one potential partner matches the set of input parameters.

In embodiments, the set of input parameters can specify at least one type of service, a geographical location or area, and/or at least one user preference related to working with a broker.

In embodiments, the user interface can be configured to present for display a list that includes information characterizing the at least one potential partner.

In embodiments, the user interface can be configured to present for display a map that covers a geographical area based on the set of input parameters.

In embodiments, the map can include at least one icon corresponding to the at least one potential partner, wherein the icon is located at a geographical location for the corresponding potential partner, and wherein the icon is configured to be selected by the user to present for display information characterizing the corresponding potential partner.

In embodiments, the information characterizing the at least one potential partner can include at least one of the following for a given entity: i) name of the given entity, ii) location of the given entity, iii) distance of the entity or facility, iv) at least one type of service offered by the given entity, v) summary of reviews by other users for services offered by the given entity, and vi) an estimated cost for services offered by the given entity.

In embodiments, the user interface can be configured to enable the user to access details or distribution of estimated costs for services offered by the given entity.

In embodiments, the user interface can be configured to enable a user to communicate with the at least one potential partner.

In embodiments, the at least one process can be configured to present for display a user interface to a user, the user interface enabling the user to generate cost estimates for specific tasks of a carbon capture and sequestration project.

In embodiments, the user interface can incorporate uncertainty and sensitivity analyses in generating the cost estimates.

In embodiments, the plurality of users can include different user types, which are based on roles and tasks performed by entities in carbon capture and sequestration projects.

In embodiments, the different user types can include at least one of: a CO2 emitter user type, a CO2 service provider user type, a broker user type, an asset owner user type, and a CO2 consumer user type.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a schematic diagram of an example digital platform for collaboration between entities for carbon capture and sequestration projects;

FIG. 2 is a schematic diagram illustrating an overview of typical roles and tasks performed by entities in carbon capture and sequestration projects;

FIG. 3 is an example table which is presented for display to a user of the platform for the example when the user is a service provider. It enables the user to specify a type of service and estimated cost for a service offered by the user of the platform;

FIG. 4 depicts an example screening user interface presented for display to a user of the platform;

FIG. 5 depicts an example map user interface presented for display to a user of the platform;

FIG. 6 depicts an example cost calculator interface presented for display to a user of the platform; and

FIG. 7 is a schematic view of an example computer system.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

The present disclosure is directed to a digital platform that interfaces to several user systems for collaboration between entities for carbon capture and sequestration projects. The digital platform can enable the identification of potential partners as well as collaboration and the exchange of services (including the exchange of cost estimates for services) related to carbon capture and sequestration projects.

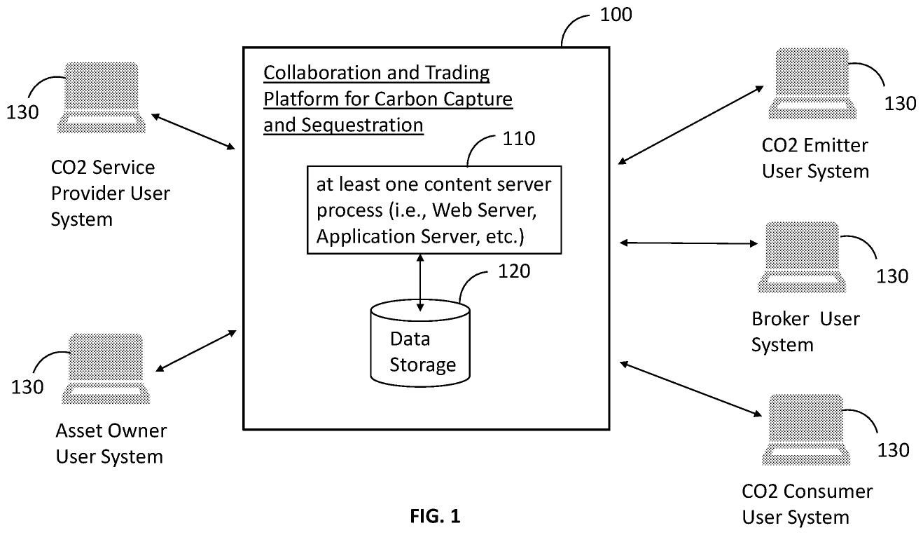

FIG. 1 shows an example digital platform 100, according to one example of the current disclosure. The digital platform 100 includes at least one content server process 110 that interfaces with data storage 120. The platform 100 communicates with user systems 130 through one or more data communication networks (not shown). The remote user systems 130 access the platform 100 through the data communication network(s), and the at least one content server process 110 functions to interact with the remote user systems 130 and dynamically generate and present for display information to users via the user systems 130 as described herein in more detail. In one example, the at least one content server process 110 can include the functionality of a web server and/or an application server configured to interact with the user systems 130 and dynamically generate and present for display information to the users of the user systems 130 as described herein in more detail. The information presented for display to the user can be stored in the data storage 120 and loaded from the data storage 120 by the content server process 110. The user systems 130 can include software applications, such as a web browser or other application, that executes on the respective user systems and interfaces to the platform 100 via one or more data communication networks. The content server process 110 can be implemented by data processing functionality in a cloud computing environment (such as Amazon Web Services, Google Cloud, and Microsoft Azure), on-premises data processing functionality, or a hybrid architecture including data processing functionality in a cloud computing environment together with on-premises data processing functionality. The data communication network(s) may be any means of enabling communication between the platform 100 and the user systems 130, such as the Internet, a LAN, WAN, MAN, wireless access network, wired access network, or the like, or any combination of such networks. The user systems 130 can be any one of several different types of computer systems, including PCs, workstations, notebooks, tablets, smartphones, other mobile devices, and other data communication-enabled computing devices.

The user systems 130 that access the platform 100 can be operated by different user types (or categories of users), which are based on roles and tasks performed by entities in carbon capture and sequestration projects. A given user operating a user system 130 can access the platform 100 to establish a corresponding user account or profile with suitable login credentials (e.g., username and password and possibly other login credentials) stored by the platform 100. The given user can also specify a particular user type associated with the given user and corresponding user profile. Subsequent access to the platform 100 by the given user through operation of a user system 130 employs a user authentication process that authenticates the given user with the login credentials of the given user stored by the platform. Once the given user is authenticated, the interaction with the given user and the information presented for display to the given user by the content server process 110 can be configured or tailored according to the user type associated with the given user. The platform 100 can provide for communication from the platform to users as well as communication between users. Such communication can involve in-app messaging, e-mail messaging, real-time messaging, real-time chat, voice or video communications, and other forms of messaging.

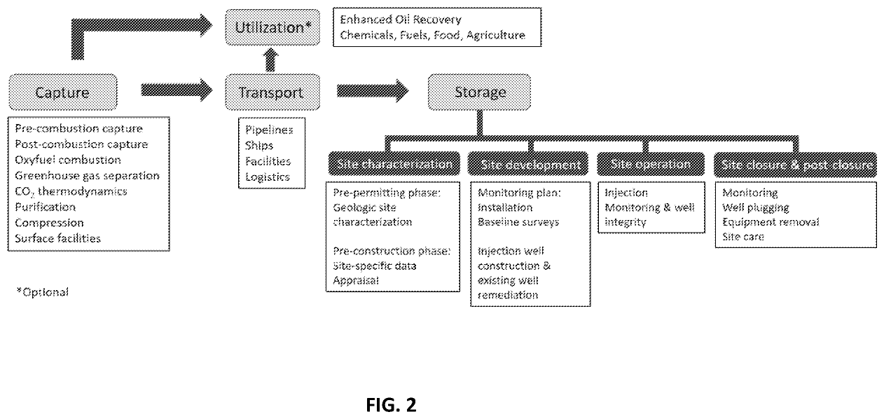

FIG. 2 shows an overview of typical roles and tasks performed by entities in carbon capture and sequestration projects, which include a capture stage, a transport stage, a storage state, and an optional utilization stage. In the capture stage, carbon dioxide or related gas is captured from a source, such as a fossil fuel power plant or industrial process. The capture of the carbon dioxide or related gas can occur prior to combustion of hydrocarbons (i.e., pre-combustion capture), subsequent to combustion of hydrocarbons (i.e., post-combustion capture), in conjunction with oxyfuel combustion, in conjunction with greenhouse gas separation, or other suitable processes. The capture stage can also involve thermodynamic modeling to understand the constituents and mixtures of the captured gas and purification of the captured gas to filter out unwanted constituents. The resulting captured gas is compressed prior to transport to reduce volume, typically into a liquid phase, and possibly stored in a surface facility (i.e., tank). In the transport phase, the liquid phase is transported to a planned storage site. The transport phase can involve pipelines, ships, and other surface facilities that are used to transport the liquid phase and possibly store the liquid phase in a surface facility (i.e., tank). The transport phase can involve logistics to manage the transport of the liquid phase to the planned storage site. In the storage phase, an injection well at the planned storage site is operated to inject the liquid phase into a subterranean earth formation. The subterranean earth formation permanently stores and sequesters the liquid phase that is injected into the formation. The storage phase can involve or rely on a number of planning tasks, such as site characterization (including pre-permitting tasks related to geographic site characterization as well as pre-construction tasks related to site-specific data appraisal), site development (including monitoring planning tasks related to installation baseline surveys as well as tasks related to injection well construction and existing well remediation), site operation (including tasks related to injection well monitoring and well integrity), and site closure (including tasks related to well plugging, equipment removal, and site care). The optional utilization stage can use the liquid phase (or possibly captured gas prior to liquification) as part of an industrial process, such as for enhanced oil recovery, chemical processing, fuel generation, food preparation, and agricultural processes.

In embodiments, the user types that access the platform 100 can include carbon dioxide (CO2) service providers, CO2 emitters, brokers, asset owners, optionally CO2 consumers, and possibly other user types. The CO2 Service Providers represent entities that provide services or goods related to one or more stages of carbon capture and sequestration projects as outlined in FIG. 2. For example, a CO2 Service Provider can provide for purification of carbon dioxide which is needed prior to the transport, the transport itself, and any other service or goods or other offerings related to the capture, transportation, utilization, or storage stages of carbon capture and sequestration projects. The CO2 emitters represent entities or industrial sites that emit carbon dioxide or related gas. The CO2 emitter can operate a corresponding user system to access the platform to specify an industry type, type of service required, an estimated amount of emitted carbon dioxide or related gas for which capture, transport, and storage is needed as well as the aspired duration of injection for permanent storage and sequestration. Brokers can represent agents that communicate with and establish relationships between users for one or more stages of carbon capture and sequestration projects. For example, a Broker can provide execution services, advice, or solutions to other users for one or more stages of the carbon capture and sequestration projects. Asset Owners represent entities that own or control facilities that can be used for the capture, transportation, utilization, or storage stages of carbon capture and sequestration projects. For example, an Asset Owner can own or control a depleted oil field, gas field, or saline reservoir that can be used as a storage site for one or more carbon capture and sequestration projects. Such an Asset Owner can operate a user system to access the platform and specify a type of available storage and the capacity of liquid phase that can be stored. The CO2 consumers represent entities or facilities that use the liquid phase (or possibly captured gas prior to liquification) in their industrial processes, such as for enhanced oil recovery, chemical processing, fuel generation, food preparation, and agricultural processes. A CO2 consumer can operate a user system to access the platform and specify the type and capacity/volume of the liquid phase (or possibly captured gas prior to liquification) that is required for use over time.

The content server process 110 can be configured to provide each user with an option to specify and save work product or other information, such as a specification related to one or more stages of one or more carbon capture and sequestration projects. Such information can be stored as part of the user profile for the corresponding user, which is stored in the data storage 120. In embodiments, the content server process 110 can be configured such that user profiles can be modified, appended, and updated at any time by the appropriate users.

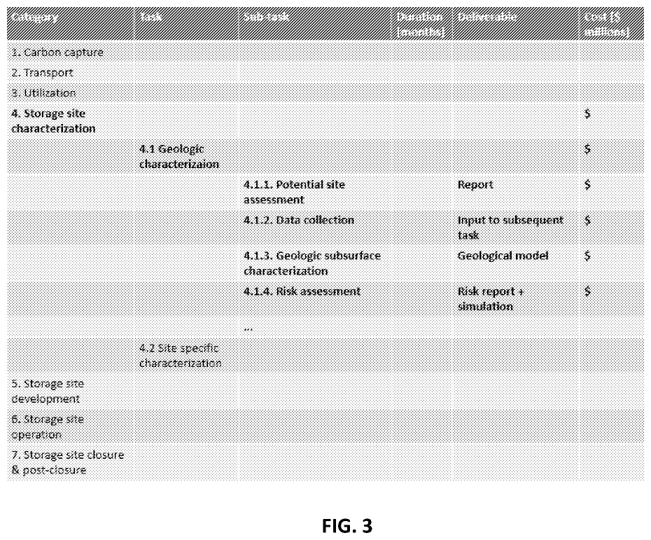

In addition to the parameters mentioned above, the content server process 110 can be configured to enable a user to specify a facility's geographic location (for example, by GPS coordinates or other geofencing techniques) and contact information to facilitate the operation of the screening user interfaces as described herein. Furthermore, a CO2 consumer may specify the state in which the carbon dioxide is required (e.g., purified), and a CO2 service provider can specify an estimated price range for services offered by the CO2 service provider. For the latter, the content server process 110 can be configured to present for display a table covering all of the stages of the carbon capture and sequestration projects. The table can be used to select the category and tasks for which a service is offered, and to specify an estimated price range by considering resources, material, duration, and risk. Depending on the CO2 service provider, the type of service, and the service provider's experience in carbon capture and sequestration projects, the cost estimate may initially be crude but will become more accurate once a project materializes and matures. FIG. 3 depicts a conceptual draft of such a table, which can be presented for display to CO2 service providers to enable a CO2 service provider to specify type of service and estimated cost for a service offered by the CO2 service provider, exemplified on the category “Storage Site Characterization”. The categories reflect the stages of carbon capture and sequestration projects as outlined in FIG. 2. These elements of the table can be fixed by design and include the minimum information needed for specific tasks, while permitting the addition of optional sub-tasks for more detailed and precise cost estimates.

In addition, the content server process 110 can also be configured to provide screening (or search) user interfaces that are presented for display to corresponding users of the platform to identify potential partners for each stage of a carbon capture and sequestration project. The potential partners can include users of the platform or non-user entities whose services are determined from public or proprietary data sources. In embodiments, the screening user interfaces can be tailored for the different user types of the platform, whereby users of a given user type will interact with a corresponding screening user interface to specify input parameters relevant to the given user type.

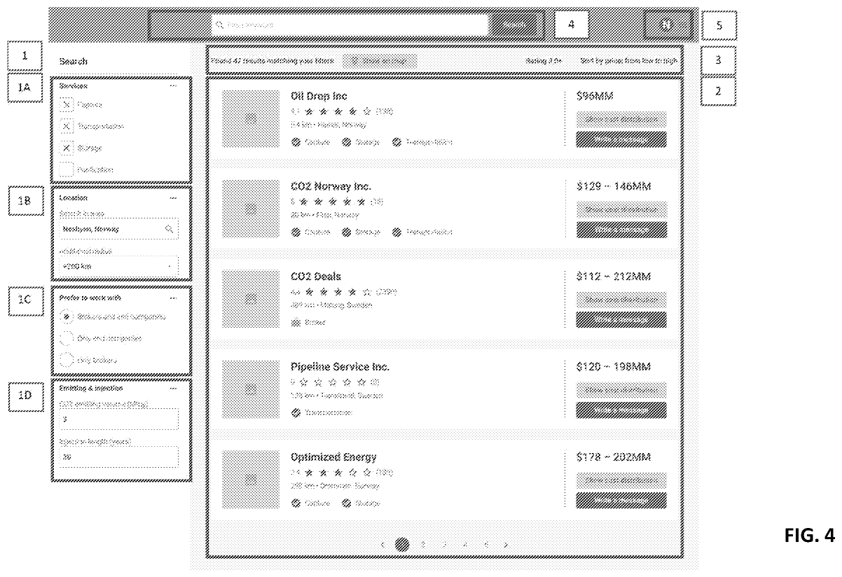

FIG. 4 illustrates an example screening user interface presented for display to a CO2 Emitter user. In this case, the CO2 Emitter user can specify search parameters in four boxes 1A, 1B, 1C, and 1D on the left-hand side of the user interface as follows:

Box 1A: Type of service needed. Multiple choices are possible. An optional sub-menu per user type can be accessed to further specify the task for which a service is needed. These tasks are linked to the table illustrated in FIG. 3, which is stored as part of a user profile for one or more CO2 service providers.

Box 1B: Geographical location (for example, by city, state (if needed) and country) and radius from the geographical location of the CO2 emitting facility considered for finding partners. There can also be an option to search by country or continent; in which case the search by radius is disabled or muted.

Box 1C: Indication of preferred way of engagement, either directly with a company, through a broker or both.

Box 1D: Amount of carbon dioxide to be purified, transported and/or stored as well as the desired duration of storage.

The entities that match the specified search parameters are identified and presented for display in Box 2 of the screening user interface. Each matching entity can be listed by name with a short description of offered service, a cost estimate (if available), geographic location (for example, by city, state (if needed), and country), and a rating based on other user experiences with the specific entity (if available). The list can be searched by one or more keywords specified by user input in Box 4. The user profile of the CO2 Emitter user that is viewing the screening user interface can be accessed by user input with Box 5 of the interface.

In another example, a CO2 service provider user can be presented with the screening user interface similar to FIG. 4 to identify potential partners for a carbon capture and sequestration project. Considering the underlying information from the service provider on its service specialization such as CO2 purification or transport, a set of potential partners that match the user-specified input parameters can be identified. The set of potential partners can be based on public information on CO2 emission by industry within the area of interest and proprietary data shared by CO2 emitters. Hence, for the screening user interface to access relevant information and deliver appropriate results, the search parameters defined above are relevant and useful.

In another example, a Broker user can be presented with a similar screening user interface to identify potential partners for a carbon capture and sequestration project. In this case, the screening user interface can be configured to enable the Broker user to specify a location and radius from the Broker's office considered for finding potential partners. There will be also an option to search by country or continent; in this case, the search by radius can be disabled or muted. In this example, only entities that specify in their user profile that an engagement through a broker is desired will be presented for display in the list of possible partners as generated and presented for display by the screening user interface.

In still another example, an Asset Owner user can be presented with a similar screening user interface to identify potential partners for a carbon capture and sequestration project. In this case, the screening user interface can be configured to enable the Asset Owner user to specify the type of asset provided.

In yet another example, a CO2 consumer user can be presented with a similar screening user interface to identify potential partners for a carbon capture and sequestration project. In this case, the screening user interface can be configured to enable the CO2 consumer user to specify a set of search input parameters as follows:
type of business partner (i.e., CO2 emitter, CO2 service provider, Asset Owner or CO2 consumer). Multiple choices are possible.
geographic location (for example, by city, state (if needed), and country) and radius from the location of the CO2 consumer user facility that is considered for finding partners. There will be also an option to search by country or continent; the search by radius is then disabled or muted.
preferred way of engagement, either directly with a company, through a broker or both.
amount of carbon dioxide needed for use and duration of expected use.

In this manner, the content server process 110 can be configured to identify an optimal pathway aligned with the user requirements either for all stages of a carbon capture and sequestration project, or just for a desired task or step of a carbon capture and sequestration project. Such processing can involve scanning or querying a database which is fed by public or proprietary data sources related to carbon capture and sequestration project and the user receives a list of entities related to such tasks together with an estimation of costs for each task (See block 2 of FIG. 4).

In embodiments, the content server process 110 can be configured to generate and present for display to a user an integrated map user interface for one or more stages of a carbon capture and sequestration project. The map user interface can be configured to show existing infrastructure (such as pipelines, surface storage facilities, storage sites for storage and sequestration, etc.) as well as potential partners that match input parameters specified by the user. The infrastructure and potential partners can be depicted visually by dedicated icons referring to the industry and service. The user can select one or more of the icons corresponding to the potential partners to display more information about the entity, offered services, and an estimated cost quote. The user can increase or decrease the geographical area covered by the map user interface (which is preferably set by a radius relative to an emitting facility) in order to see the icons representing the infrastructure and potential partners that are located in the geographical area covered by the map user interface. Communication or engagement with one or more of the potential partners identified by the map user interface can be initiated by the user clicking on a predefined interface element (e.g., write message button). A service provider may also provide a range of potential service costs for a given task or stage of a carbon capture and sequestration project.

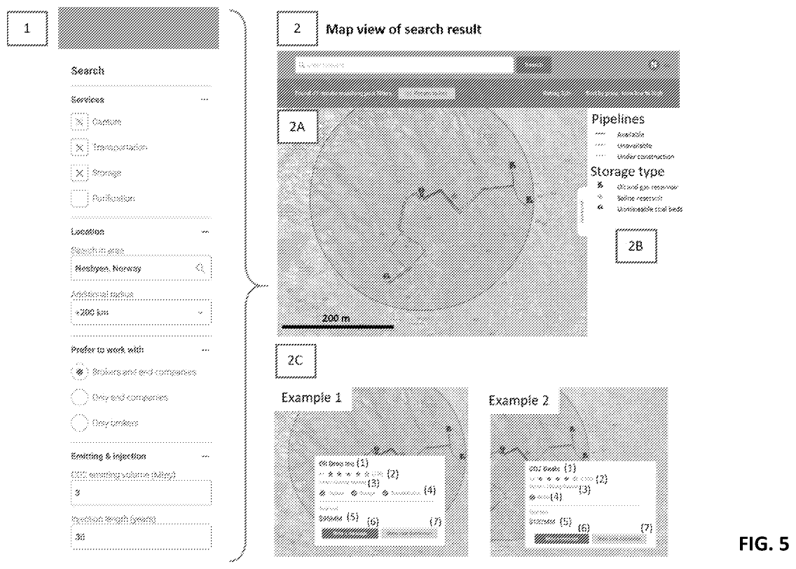

FIG. 5 shows an example map user interface generated by the content server process 110 and presented for display to a CO2 Emitter user, which includes the following components:
Block 2A: a map view of an area corresponding to geographical area/radius input parameters of the search menu as shown, e.g., with a radius around the user's start location. The potential partners and infrastructure that match the service-type input parameters as specified by the user in the search menu (block 1) are depicted by dedicated icons within the map area at their corresponding geographical locations (which can be defined by GPS coordinates or other geofencing techniques).
Block 2B: a legend of the icons depicted in the map area map, e.g., pipeline infrastructure and type of potential business partner.
Block 2C: a link to a short description of a potential partner and the services offered by the potential partner when the user clicks on the icon corresponding to the potential partner. See Examples 1 and 2 of FIG. 5. The information that is displayed for a potential partner can include a company name, rating of the company's services by other users, geographic location of the service provider, type of engagement and service(s) provided, and estimated total costs of service as shown. Communication with a specific potential partner identified by the map user interface can be initiated by the user clicking on a write message button (item 6 of FIG. 5). The service provider may also provide a range of potential service costs for a given task or stage of a carbon capture and sequestration project, which can be accessed and reviewed by the user through the “Show Cost Distribution” button (item 7 of FIG. 5).

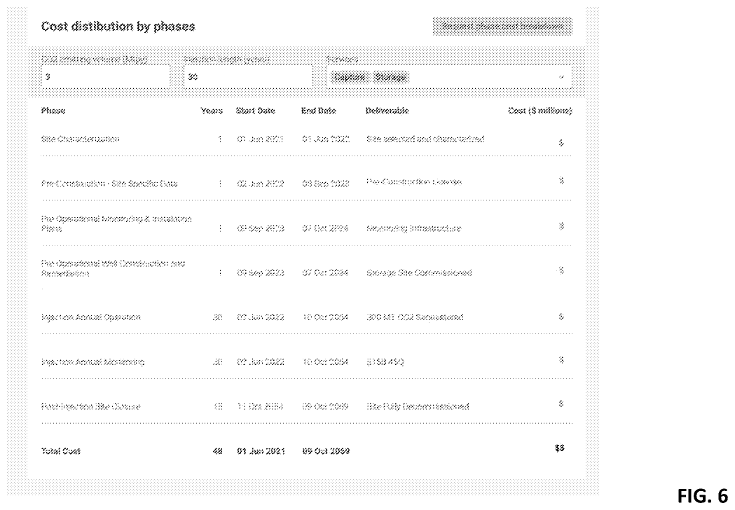

In embodiments, the content server process 110 can also be configured to generate and present for display to a user a cost calculator interface for one or more stages of a carbon capture and sequestration project. This cost calculator interface enables the user to quickly generate cost estimates for the tasks of one or more stages of a carbon capture and sequestration project. An example cost calculator interface is shown in FIG. 6. The cost calculator interface can incorporate uncertainty and sensitivity analyses and estimates costs, revenues, and profit-sharing adapted to the selected location and partners. The cost calculator interface is flexible and can be extended to include updated incentive schemes and prediction economic modeling. The incentives can be further segmented, e.g., by company, source of emission, country, and type of application. A full understanding of the cost break-down and potential incentives or regulations can be a significant driver for CO2 emitters to start planning a carbon capture and sequestration project. The platform will benefit from all existing technologies, which span the full end-to-end lifecycle of a carbon capture and sequestration project and will effectively contribute to increased deployment of large-scale carbon capture and sequestration projects.

Advantageously, the digital platform as described herein can help participants forge partnerships and facilitate transactions between asset owners, CO2 emitters, CO2 consumers, and CO2 service providers. The platform can present an intuitive overview of potential participants in a carbon capture and storage project, provide tools to calculate cost estimates of services, and enable trading of services and carbon dioxide through the platform. The carbon capture and storage value chain will be streamlined, and the complexity of the process lifecycle can be reduced.

Additionally or alternatively, the digital platform as described above can be adapted to provide for collaboration between users that represent entities that provide services or facilities related to other energy-related projects, such as hydrogen projects and geothermal projects. In these energy-related projects, the respective users of the digital platform can be similar to those described above. There is an increasing need for a mix of energies to meet the net zero targets, and this requires a polyvalent platform providing the full overview of services and connecting energy transition players.

For example, hydrogen projects involve the processes and pathways in the lifecycle of hydrogen, which include (1) hydrogen production, (2) hydrogen storage, (3) transportation of hydrogen, and (4) utilization of hydrogen. These four phases can be further broken down into different tasks and technologies, e.g., as described by Osman et al., “Hydrogen production, storage, utilisation and environmental impacts: a review,” Environmental Chemistry Letters, Springer, 2021, https://doi.org/10.1007/s10311-021-01322-8.

In hydrogen projects, the hydrogen production can involve electrolysis, thermochemical conversion, biochemical conversion. The hydrogen storage can involve storing hydrogen as compressed gas in underground caves or tanks, converting hydrogen from a gas to liquid form, or converting hydrogen from a gas or liquid to a solid form. The transportation of hydrogen can involve a pipeline for carrying hydrogen as compressed gas, tube trailers for carrying hydrogen as compressed gas, trucks that carry hydrogen in liquid form, and carriers for carrying hydrogen in high density form. The utilization (end use) of hydrogen can involve trains or locomotives that consume hydrogen, fuel cell vehicles that consume hydrogen, hybrid vehicles that consume hydrogen, generation of power that consumes hydrogen, and generation of energy in refineries by processes that consume hydrogen.

To adapt the digital platform for collaboration between entities in hydrogen projects, the CO2 emitter user type can be replaced by a hydrogen producer user type, a CO2 service provider user type can be replaced by a hydrogen service provider user type, an asset owner user type for CO2 storage can be replaced by an asset owner type for hydrogen storage, and a broker for carbon capture and sequestration projects can be replaced by CO2 process lifecycle services by a broker for hydrogen projects. A CO2 consumer user type can be replaced by a hydrogen utilization user type, and CO2 emission rates are changed to hydrogen production volumes.

Geothermal projects typically involve a geothermal power plant or geothermal heat pump. In the case of a geothermal power plant, the geothermal projects can involve (1) the production of hot water or steam, (2) generation of electricity, and (3) reinjection of cold water into a subterranean reservoir. The generated electricity is supplied into the electricity network and can be utilized (4) by various industries or consumers. Again, the digital platform could be easily adapted to address all users in such geothermal projects.

There is an increasing need for a mix of energies to meet net zero targets for carbon emission. The digital platform can help meet this need by providing the full overview of services offered by energy transition players and connecting such energy transition players. Therefore, the digital platform as described herein can readily be extended to add a new list of users from the low-carbon energy space and their requirements, together with their interconnection in the selected energy transition application.

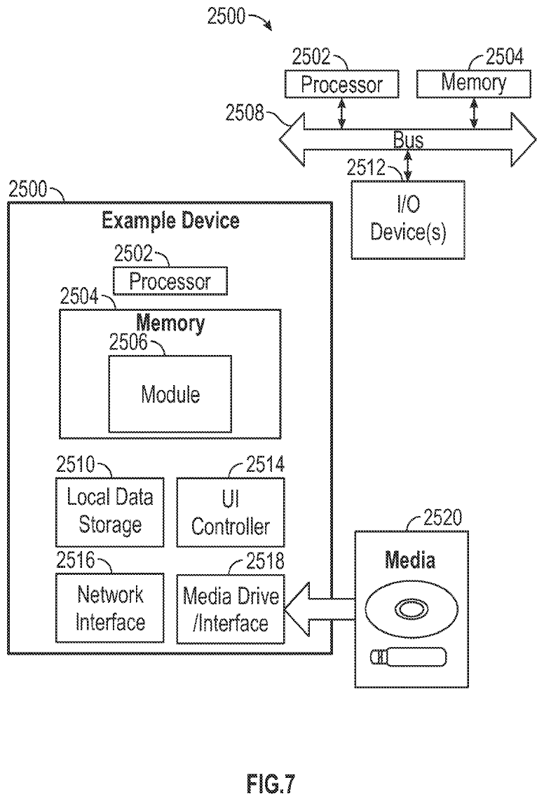

FIG. 7 illustrates an example device 2500, with a processor 2502 and memory 2504 that can be configured to implement various embodiments of the digital platform and user systems as discussed in the present application. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more of computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth). One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network. A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various systems and processes of present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable, and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer. Some of the methods and processes described above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, general-purpose computer, special-purpose machine, virtual machine, software container, or appliance) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Some of the methods and processes described above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A computer-implemented method involving a plurality of users that represent entities that provide services or facilities for carbon capture and storage projects, comprising:
providing a platform that is accessed by the plurality of users operating user systems, wherein the platform executes at least one process configured to enable collaboration between users for carbon capture and sequestration projects.

2. A computer-implemented method according to claim 1, wherein:
the at least one process is configured to enable a user to identify at least one potential partner related to a carbon capture and sequestration project.

3. A computer-implemented method according to claim 2, wherein:
the at least one potential partner includes at least one user of the platform; and
the at least one potential partner includes at least one entity that is not a user of the platform.

4. A computer-implemented method according to claim 1, wherein:
the at least one process is configured to enable collaboration between users and exchange of services for carbon capture and sequestration projects.

5. A computer-implemented method according to claim 1, wherein:
the at least one process is configured to present for display a user interface to a user belonging to said plurality of users, said user interface enabling the user to specify a set of input parameters that are used to identify at least one potential partner for a carbon capture and storage project, wherein the at least one potential partner matches the set of input parameters.

6. A computer-implemented method according to claim 5, wherein:
the set of input parameters specifies at least one type of service;
the set of input parameters specifies a geographical location or area; and
the set of input parameters specifies at least one user preference related to working with a broker.

7-9. (canceled)

10. A computer-implemented method according to claim 5, wherein:
the user interface is configured to present for display a list that includes information characterizing the at least one potential partner; and
the information characterizing the at least one potential partner includes at least one of the following for a given entity: i) name of the given entity, ii) location of the given entity, iii) distance of the entity or facility, iv) at least one type of service offered by the given entity, v) summary of reviews by other users for services offered by the given entity, and vi) an estimated cost for services offered by the given entity.

11. A computer-implemented method according to claim 10, wherein:
the user interface is further configured to enable the user to access details or distribution of estimated costs for services offered by the given entity.

12. A computer-implemented method according to claim 5, wherein:
the user interface is configured to present for display a map that covers a geographical area based on the set of input parameters; and
the map includes at least one icon corresponding to the at least one potential partner, wherein the icon is located at a geographical location for the corresponding potential partner, and wherein the icon is configured to be selected by the user to present for display information characterizing the corresponding potential partner.

13-16. (canceled)

17. A computer-implemented method according to claim 1, wherein:
the at least one process is configured to present for display a user interface to a user belonging to said plurality of users, said user interface enabling the user to generate cost estimates for specific tasks of a carbon capture and sequestration project; and
the user interface incorporates uncertainty and sensitivity analyses in generating the cost estimates.

18. (canceled)

19. A computer-implemented method according to claim 1, wherein:
the plurality of users comprises different user types, which are based on roles and tasks performed by entities in carbon capture and sequestration projects.

20. A computer-implemented method according to claim 19, wherein:
the different user types include at least one of: a CO2 emitter user type, a CO2 service provider user type, a broker user type, an asset owner user type, and a CO2 consumer user type.

21. (canceled)

22. A computer-implemented method involving a plurality of users that represent entities that provide services or facilities for energy-related projects, comprising:
providing a platform that is accessed by the plurality of users operating user systems, wherein the platform executes at least one process configured to enable collaboration between users for energy-related projects.

23. A computer-implemented method according to claim 22, wherein the at least one process is configured to enable a user to identify at least one potential partner related to an energy-related project.

24. A computer-implemented method according to claim 23, wherein:
the at least one potential partner includes at least one user of the platform; and/or
the at least one potential partner includes at least one entity that is not a user of the platform.

25-32. (canceled)

33. A computer-implemented method according to claim 22, wherein:
the user interface is configured to present for display a map that covers a geographical area based on the set of input parameters.

34. A computer-implemented method according to claim 33, wherein:
the map includes at least one icon corresponding to the at least one potential partner, wherein the icon is located at a geographical location for the corresponding potential partner, and wherein the icon is configured to be selected by the user to present for display information characterizing the corresponding potential partner.

35-36. (canceled)

37. A computer-implemented method according to claim 22, wherein:
the user interface is configured to enable a user to communicate with the at least one potential partner.

38. A computer-implemented method according to claim 22, wherein:
the at least one process is configured to present for display a user interface to a user belonging to said plurality of users, said user interface enabling the user to generate cost estimates for specific tasks of an energy-related project; and
the user interface incorporates uncertainty and sensitivity analyses in generating the cost estimates.

39-40. (canceled)

41. A computer-implemented method according to claim 22, wherein:
the energy-related projects involve at least one of: carbon capture and sequestration, hydrogen production, and a geothermal power plant or geothermal heat pump.

42. (canceled)
